(19) United States
(12) Patent Application Publication
(10) Pub. No.: US 2025/0271335 A1
(43) Pub. Date: Aug. 28, 2025

(54) AIR SAMPLING APPARATUS

(71) Applicant: Frontier Microscopy US Inc., Berkeley, CA (US)

(72) Inventors: Jordan Gallagher-Gruber, San Francisco, CA (US); Michael Nguyen, Sacramento, CA (US)

(21) Appl. No.: 19/063,136

(22) Filed: Feb. 25, 2025

Related U.S. Application Data
(60) Provisional application No. 63/558,277, filed on Feb. 27, 2024.

(51) Int. Cl. G01N 1/22

(52) U.S. Cl. CPC G01N 1/2208

(57) ABSTRACT

An air sampling apparatus comprises a removable air-testing cassette comprising a particulate capture material and a docking station comprising an electronically controllable air flow apparatus such as a fan or pump and a particulate air sampler located within the docking station, and which receives the air-testing cassette. The particulate air sampler is configured with an air flow path so that air is drawn into the air sampler by air inlets and is directed toward the particulate capture material in the cassette and out of air outlets. A control circuit is used to trigger a sampling cycle by switching on the fan or pump for a sampling interval.

### CROSS REFERENCE TO RELATED APPLICATIONS

This application claims the benefit of U.S. Provisional Patent Application No. 63/558,277, filed Feb. 27, 2024, the content of which is hereby incorporated by reference in its entirety.

### TECHNICAL FIELD

The present disclosure relates to air sampling apparatus. In a particular form the present disclosure relates to air sampling apparatus for detecting the presence of mold.

### BACKGROUND ART

It is estimated that 70% of US homes have hidden mold growth. The presence of mold in homes can have adverse health effects, in particular for children and the immunocompromised. Infants exposed to mold have 3× chance of developing asthma, and mold is a leading cause of death for the immunocompromised.

However existing air sampling devices are typically large and expensive. Thus, there is a need to provide improved air sampling apparatus, methods and systems, or to at least provide a useful alternative to existing apparatus, methods and systems.

### SUMMARY

According to a first aspect, there is provided an air sampling apparatus comprising:
a removable air-testing cassette comprising a frame, a support surface, and a particulate capture material, wherein the frame supports the support surface, and the particulate capture material is located on at least one side of the support surface, wherein a thickness of the removable air-testing cassette is less than 20 mm;
a docking station comprising:
   an electronically controllable air flow apparatus;
   a particulate air sampler located within the docking station comprising a housing and an interior frame, wherein the housing comprises one or more air inlets, one or more air outlets, and a receiving aperture configured to receive and support the removable air-testing cassette, wherein the interior frame comprises a slit located below the particulate capture material and the particulate air sampler is configured with an air flow path such that when the electronically controllable air flow apparatus is switched on, air is drawn into the particulate air sampler by the one or more air inlets and is directed through the slit to the particulate capture material on the support surface, and then out through the one or more air outlets;
   a control circuit configured to receive at least a start input from a user input actuator to trigger a sampling cycle by switching on the electronically controllable air flow apparatus on for a predefined sampling interval.

In one form, the removable air-testing cassette has a thickness of less than 6.5 mm.

In one form, the air sampling apparatus further comprises an air sampler cover configured to be moved between a resting location in which the particulate air sampler apparatus and the one or more air inlets and one or more air outlets are covered, and a sampling location in which the cover is moved to a location to expose at least a portion of the one or more air inlets and one or more air outlets are uncovered, and comprising a rear access opening to allow insertion and removal of the removeable air testing cassette into the receiving aperture in the particulate air sampler, wherein the control circuit is further configured to actuate movement of the air sampler cover to the sampling location prior at the start of a sampling cycle, and to return the cover back to the resting position at the end of the sampling cycle.

In one form, the electronically controllable air flow apparatus is a fan, and is located within the particulate air sampler.

In one form, the control circuit is a computing apparatus comprising one or more processors, one or more memories, and an input/output interface wherein the one or more processors are configured to switch the electronically controllable air flow apparatus on and off, according to a sampling schedule stored in the memory, or on receipt of a sampling signal received from the input/output interface.

In a further form, the docking station further comprises a cover actuator, and the memory further comprises instructions to actuate the cover actuator to move the air sampling cover from the resting location to the sampling location prior to switching the fan on, and after switching the fan off the cover actuator is actuated to allow the air sampling cover to move back to the resting location.

In one form, the particulate air sampler and cover are removable from the docking station.

In one form, the electronically controllable air flow apparatus is configured to generate a flow rate of between 3 and 20 Liters per minute.

### BRIEF DESCRIPTION OF DRA WINGS

Embodiments of the present disclosure will be discussed with reference to the accompanying drawings.

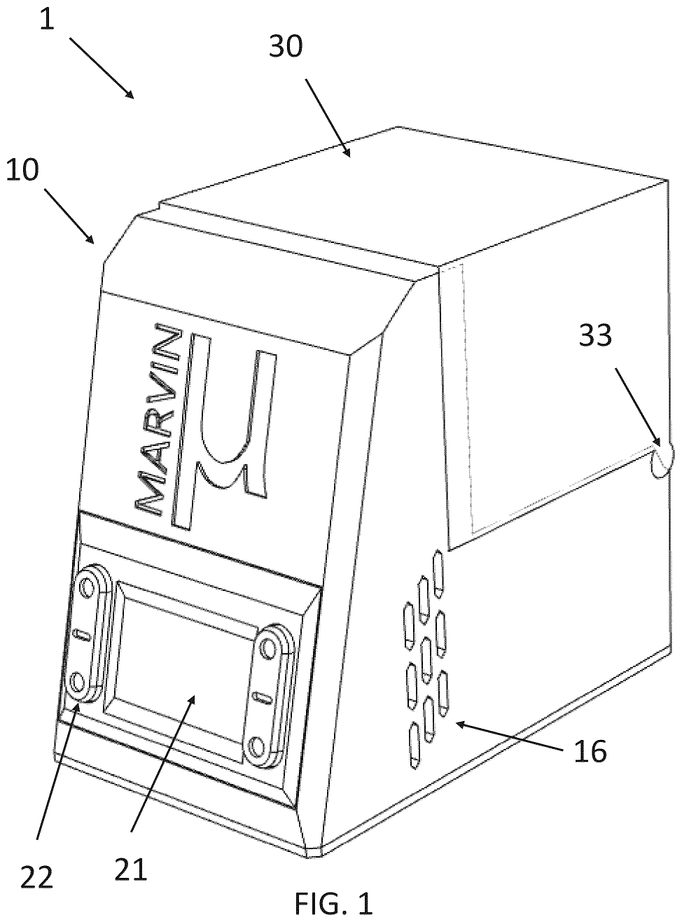

FIG. 1 is a front view of an air sampling apparatus according to an embodiment.

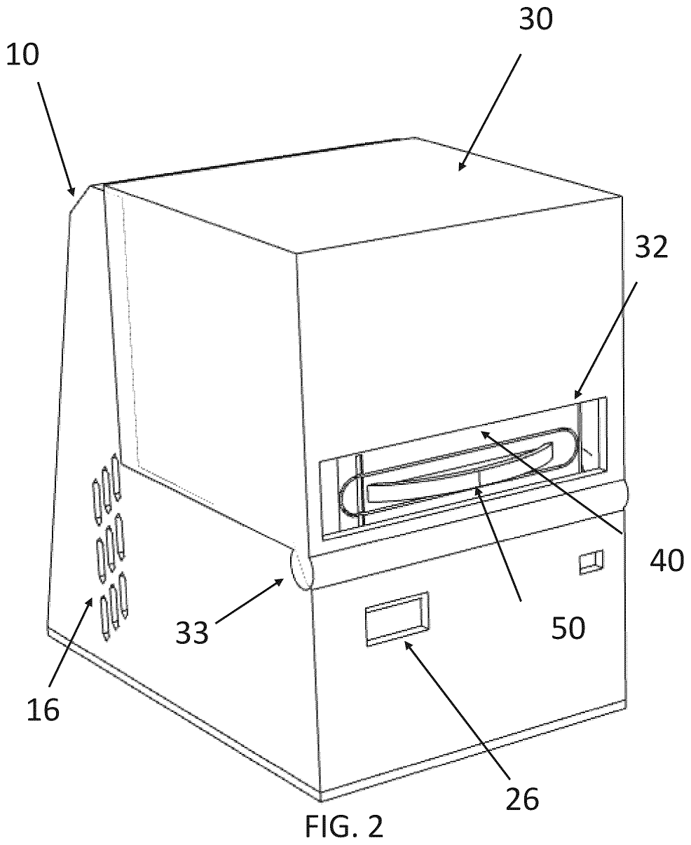

FIG. 2 is a rear view of an air sampling apparatus according to an embodiment.

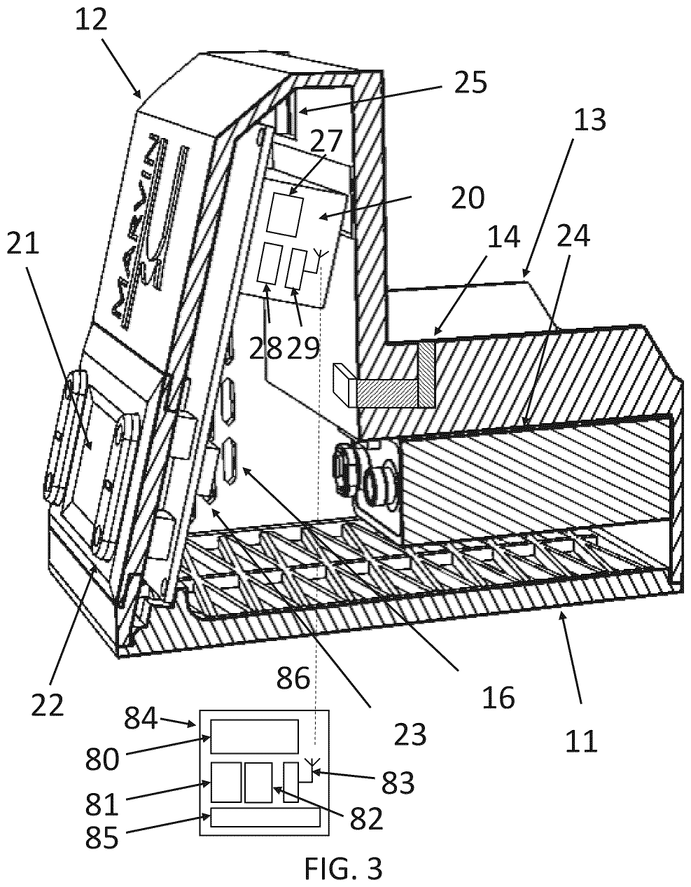

FIG. 3 is a sectional view through the housing of the re-useable sampler docking station according to an embodiment.

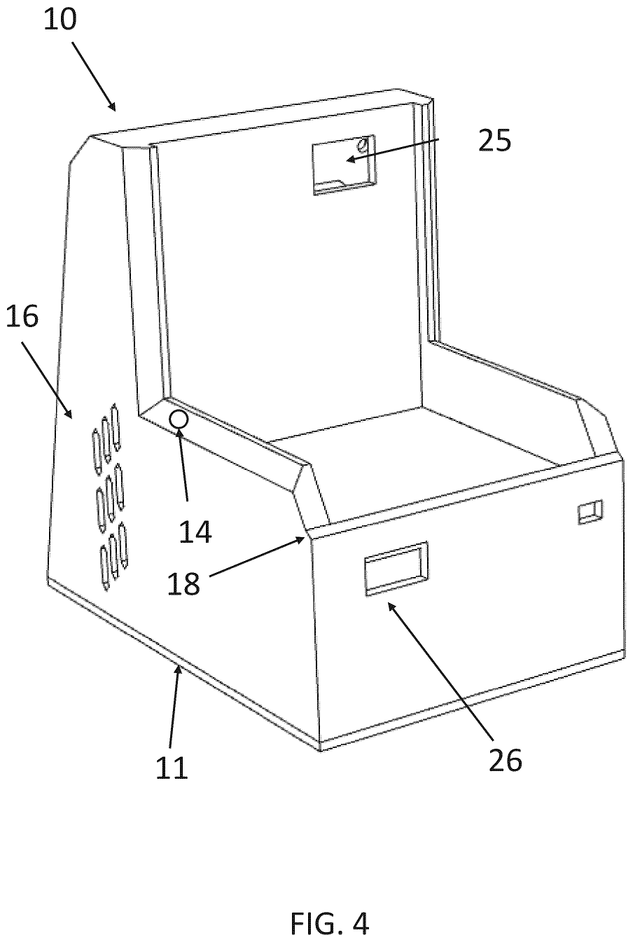

FIG. 4. is a rear view of the re-useable sampler docking station according to an embodiment.

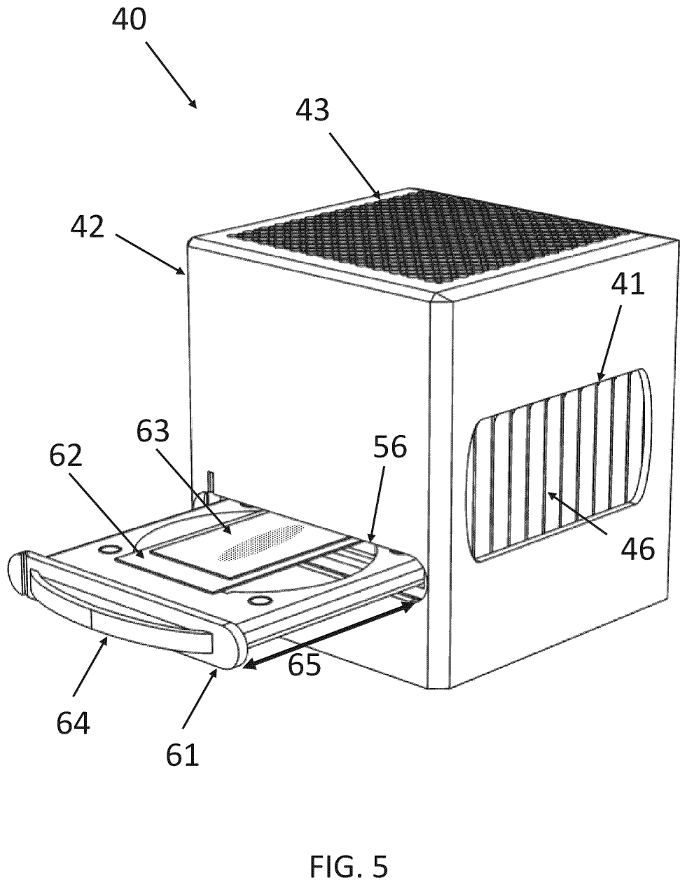

FIG. 5 is a rear view of the particulate air sampler and a removable low profile air testing cassette according to an embodiment.

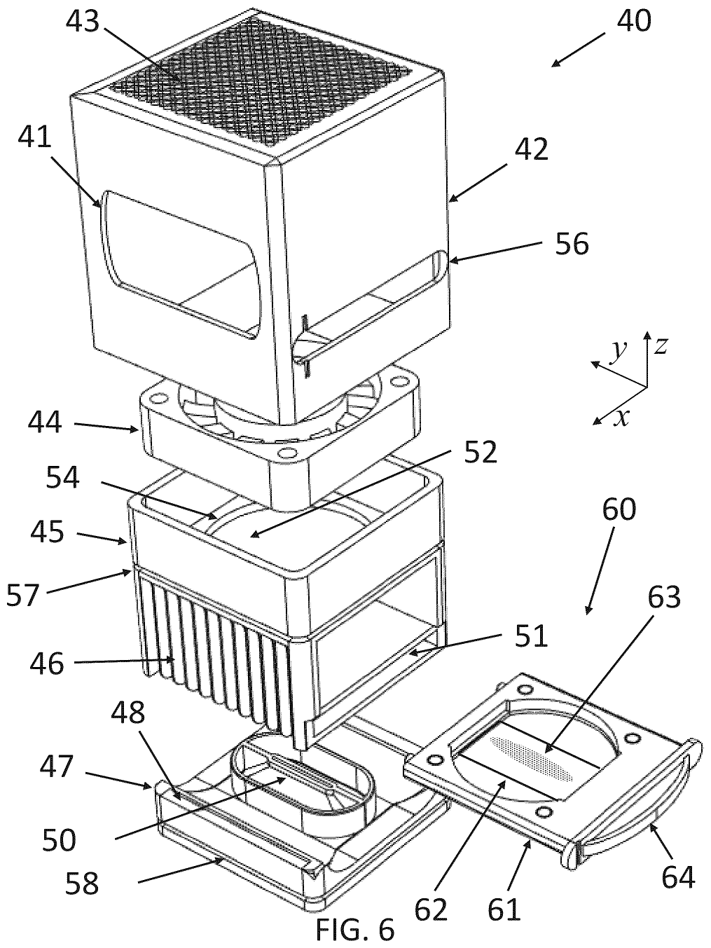

FIG. 6 is an exploded view of the particulate air sampler and a removable low profile air testing cassette according to an embodiment.

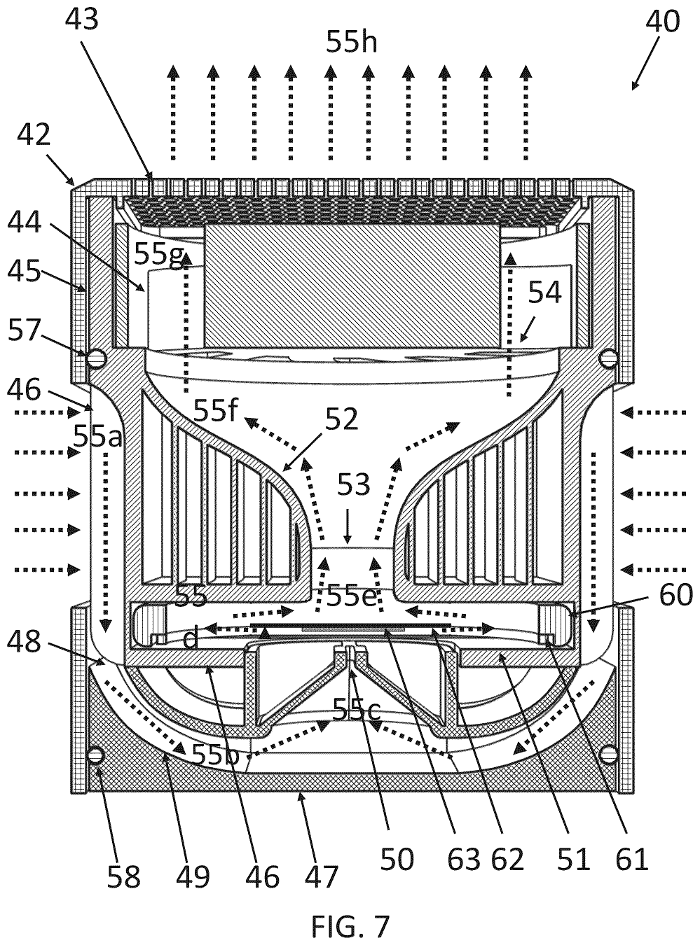

FIG. 7 is a sectional view through the particulate air sampler and removable low profile air testing cassette according to an embodiment.

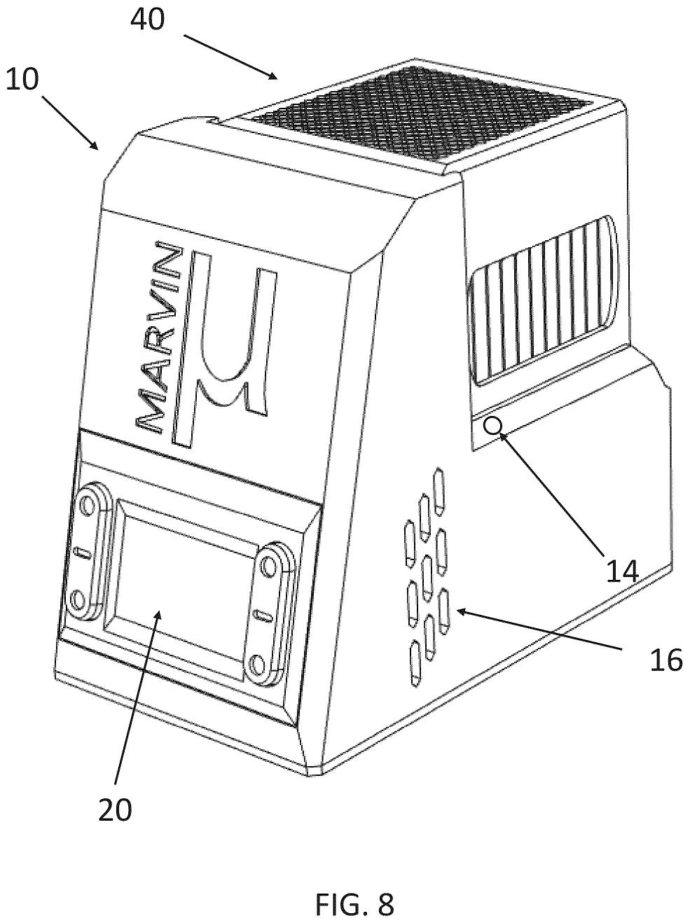

FIG. 8 is front view of the re-useable sampler docking station supporting the particulate air sampler with the cover removed according to an embodiment.

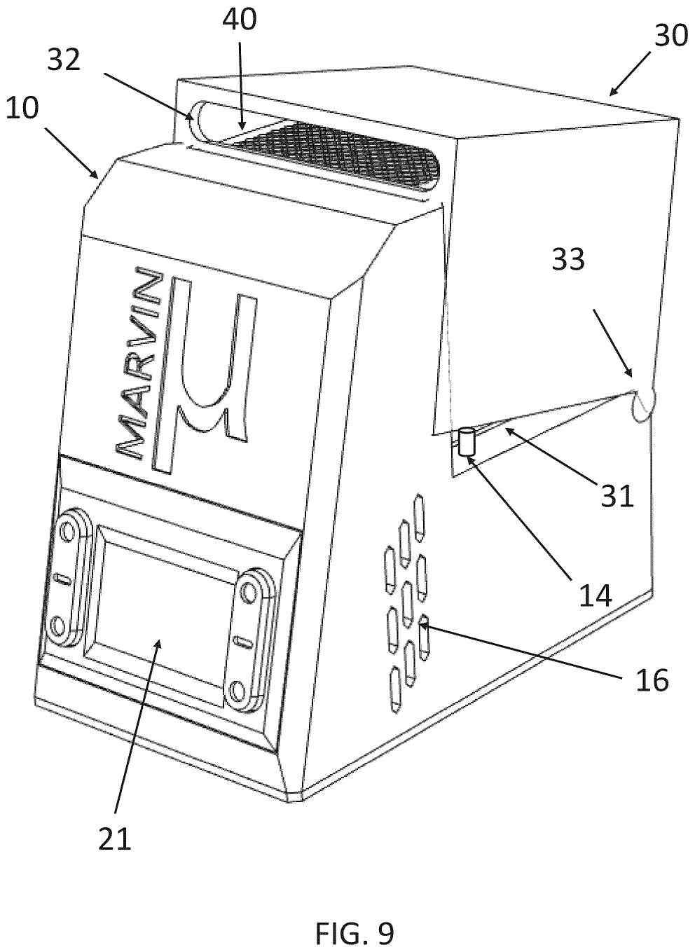

FIG. 9 is front view of the re-useable sampler docking station supporting the particulate air sampler with the cover in an air sampling location according to an embodiment.

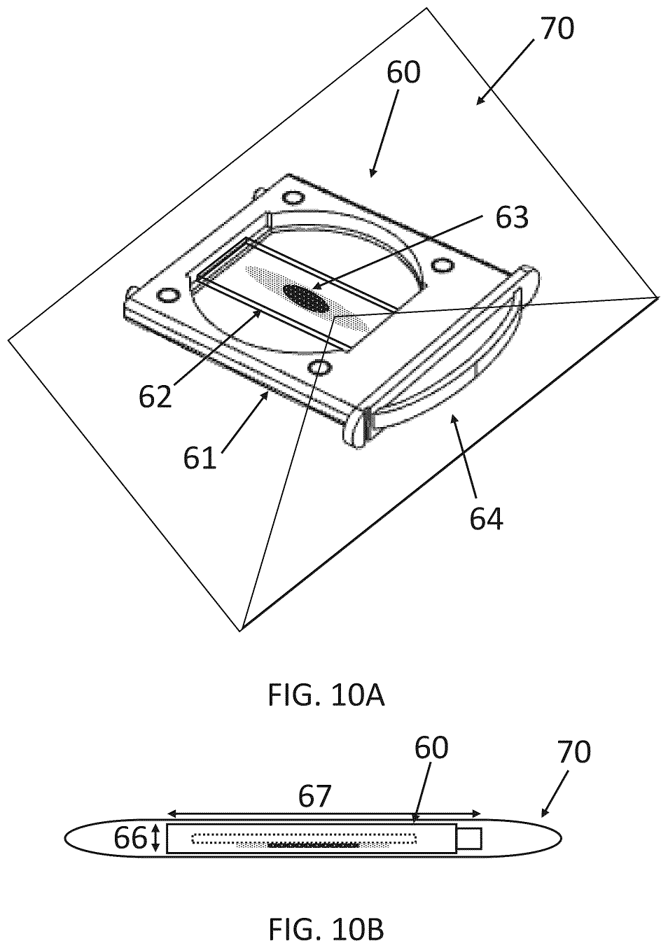

FIG. 10A is perspective view of the low profile air testing cassette 60 in an envelope 70 for shipping to a testing laboratory according to an embodiment.

FIG. 10B is side view of the low profile air testing cassette 60 in an envelope 70 according to an embodiment.

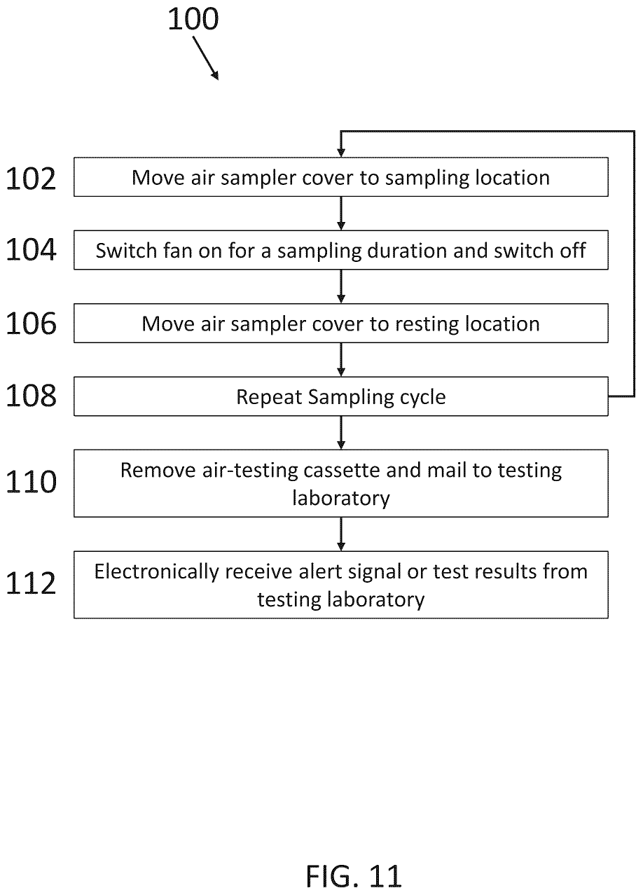

FIG. 11 is a flow chart of an operational cycle of the air sampling apparatus according to an embodiment.

In the following description, like reference characters designate like or corresponding parts throughout the figures.

### DETAILED DESCRIPTION

Referring now to FIGS. 1 and 2, there are shown front and rear views, respectively, of an air sampling apparatus 1 according to an embodiment. The air sampling apparatus 1 may be used to monitor air for the presence of air borne particulates including mold. The air sampling apparatus 1 comprises a re-useable sampler docking station 10 which supports a particulate air sampler 40 protected by a moveable air sampler cover 30 which may be moved to expose the particulate air sampler 40 and allow air flow into and out of the particulate air sampler 40. An electronically controllable air flow apparatus such as a fan or pump is used to create airflow through the particulate air sampler 40. In some embodiments the flow rate is controlled to be any value in the range of 3-20 Liters per minute. The flow rate may be controlled to be any value in the range or one or more sub-range, or a fixed value, or one of several fixed values. The rear of the air sampler 40 includes a removable low profile air testing cassette 60. In some embodiments the re-useable sampler docking station 10, particulate air sampler 40, and moveable air sampler cover 30 are an integrated or single component assembly. In some embodiments, the moveable air cover 30 and the particulate air sampler 40 are separate parts and are removeable from the docking station 10 to allow replacement of the particulate air sampler 40. An onboard control circuit 20 is used to control the pump or fan (the air flow apparatus 44) and receive user input commands via a user interface 22 to control operation of the air sampling apparatus 1. In this embodiment the control circuit 20 is a computing apparatus such as microcontroller located within the body of the docking station and connected to an external display 21 and user interface buttons 22, on the front which are used to control operation of the air sampling apparatus 1 and report status information.

FIG. 3 is a sectional view through a housing 11 of the re-useable sampler docking station 10 to show the internal components of the re-useable sampler docking station 10, and FIG. 4. is a rear view of the re-useable sampler docking station 10. The housing 11 comprises of a front portion 12 and a rear tray portion 13 which supports the moveable air sampler cover 30 and particulate air sampler 40. In this embodiment the control circuit 20 is an onboard computing apparatus located within the front portion 12 of the docking station 10 and is connected to an external display 21 and user interface actuators 22 such as buttons, mounted on the front face. Air quality sensors 23 are mounted on the interior surface of the housing (adjacent the display 21) and may include sensors such as CO2, CO, PM2.5, PM10, VOCs, etc. Air flow ports 16 are located in the side walls of the housing 12 of the re-useable sampler docking station 10 to provide air to the air quality sensors and allow cooling of the electronics. The output of the air quality sensors is provided to the onboard computing apparatus 20. A battery 24 is located under the tray portion 13. In this embodiment the battery is a rechargeable battery and a charging port 26 is provided in the rear of the housing 11 (below the tray). In this embodiment the electronically controllable air flow apparatus is a fan with a three wire connector, and an air flow apparatus power port 25 for the particulate air sampler 40 is provided in the rear surface of the top portion 12. In this embodiment the air flow apparatus is a fan with a three wire connector, two wires for power and one for a speed sensor, and thus in this embodiment the power port 25 is a fan power and speed sensor port 25. A cover actuator 14 is mounted in the side wall of the rear tray 13 to allow computer-controlled movement of the air sampler cover 30. In this embodiment the cover actuator 14 is a solenoid driven post that can be vertically extended and retracted in the side wall to push up (move) part of the base of the air cover 30 to expose the air inlets and outlets of the particulate air sampler 40.

The onboard computing apparatus 20 includes one or more processors 27, one or more memories 28, and an input/out interface 29, such as the display screen 21, user input buttons 23 and/or a wireless communications interface. In some embodiments the onboard computing apparatus is a microcontroller, microprocessor board, or a system-on-a-chip, and may be an Arduino or similar microcontroller. The one or more memories store executable instructions for instructing the one or more processors to control operation of the air sampling apparatus (and components), and to process and display sensor data. The onboard computing apparatus can be configured to control operational parameters such as when to switch on the cover actuator 14 to move the air cover 30 into, and then out of, the air sampling location (e.g., to retracted position), when, how long, and at what speed a fan in the particulate air sampler 40 is switched on for, and when to collect air quality measurements using the air quality sensors 23. The wireless communications interface may implement a Bluetooth and/or Wi-Fi communications protocol for sending and receiving data over wireless communications link 86 with a remote computing apparatus 80 executing a remote-control application, including setting the operational parameters, receiving air quality measurements, and status information on the air sampling apparatus.

It will be understood that the location of the components shown in FIG. 3 are illustrative, and that they may be located in alternate locations whilst achieving the same function. Similarly, the number of and choice of specific components may be varied. For example, two cover actuators 14 may be located in each side wall of the rear tray portion 14, or the number of openings forming the air flow port 16 may be varied. Similarly, the air flow sensors could be co-located on a PCB board on which the components of the computing apparatus are mounted. A battery access port could also be provided in a side wall to allow replacement of the battery, for example, in cases where the battery is a non-rechargeable battery. In some embodiments the user interface buttons 22 may be omitted, and the device may be remotely controlled or configured via a wireless connection 86, such as a Bluetooth or Wi-Fi_33 connection, to a remote-control application executing on remote computing apparatus 80 such as portable or desktop computing apparatus (e.g., smartphone, smart watch, laptop, or desktop computer). The remote computing apparatus 80 may comprise one or more processors 81, one or more memories 82, a communications interface 83, a display 84 and a user input interface 85. A range of user input devices may be used for the user input actuators 22, such as buttons, switches, dials, linear encoders, etc. In some embodiments the external display 21 is a touch screen display which may eliminate the need for user interface actuators (e.g., buttons) 22. In other embodiments the control circuit 20 may be PCB with components (e.g. switches, relays, timer circuits, solenoid actuators, etc.) configured to receive at least a start input to trigger a sampling cycle comprising movement of the air cover to expose the air inlets and air outlets, and actuation of the fan or pump for a predefined sampling interval (time period), after which the cover is moved back to the resting position.

FIG. 5 is a rear view of the particulate air sampler 40 and a removable low profile air testing cassette 60 according to an embodiment. FIG. 6 is an exploded view of the particulate air sampler 40 and a removable low profile air testing cassette 60 and FIG. 7 shows a sectional view illustrating the air flow through the particulate air sampler 40 and removable low profile air testing cassette 60.

Air is drawn into the particulate air sampler 40 through air inlet 41 in the side wall of the housing 42 and expelled out of air outlet 43 located in the top surface of the housing 42 by an electronically controllable air flow apparatus 44 which in this embodiment is a fan. A connector (not shown) is provided in the front side wall of the housing 42 to connect the fan to the fan power and speed sensor port 25 in the rear wall of the front portion 13 of the re-useable sampler docking station 10 to allow computer control of the fan. The computing apparatus 20 is used to switch the fan on and off. In some embodiment the fan 44 may comprise a speed sensor, which measures the speed of the fan, and which is provided to the computing apparatus 20. In some embodiments a control loop is formed in which the computing apparatus is used to set the power level sent to the fan (via port 25) and obtains a measurement of the speed of the fan. For example, the fan may be a three-wire fan in which the first two wires are ground and DC power, and the third wire is connected to a sensor that detects each full rotation of the fan to give a signal each rotation. The computing apparatus can count the number of signals over a fixed time period (e.g. 1 s) and calculate the fan speed). The measured speed can be compared to a desired speed value or a desired speed range, and the power can then be adjusted if the speed is now within an acceptance range of the target speed or speed range. In some embodiments the fan is a variable speed fan, which may be continuously variable over a speed range, or may be set at predefined steps (e.g., low, medium and high speeds) or values over a speed range, the computer may be used to set the fan speed. In other embodiments the fan may be configured to operate at a predetermined fixed speed and then the computer apparatus is used to switch the fan on and off. The speed sensor may be used to log the actual speed, and an alert condition may be raised in the speed is outside of a desired speed range.

The fan 44 is mounted in a top portion of an interior frame 45 with a bottom wall 46 which rests on a base 47. The housing 42 is located over the interior frame 45 and base 47. A series of vertical fins 46 are provided in the exterior side wall of the interior frame 45 to create multiple parallel vertical channels which extend from an elongated edge slit 48 located on a side portion of the base 47. A channel 49 in the base 47 extends transversely from the edge slit 48 to a central elongated slit 50.

A receiving slot 51 extends from the rear of the interior frame 45 into which is inserted the removable low profile air testing cassette 60. A receiving aperture 56 is formed in the housing 42 and is dimensioned and located to align with the receiving slot 51. The cover includes a rear access opening 32 to allow insertion and removal of the removeable air testing cassette 60. The removable low profile air testing cassette 60 has frame 61 which supports a support surface 62 on which is located towards a particulate capture material 63. A handle 64 is formed in the rear edge to allow insertion and removal of the removable low profile air testing cassette 60 from the receiving slot 51 and receiving aperture 56. During insertion and removal, the removable low profile air testing cassette 60 moves or slides substantially in the horizontal (y) direction. The width (x) and height (z) dimensions of the receiving slot 51 are selected to receive and support the removable low profile air testing cassette 60 such that the particulate capture material 63 is located over the central elongated slit 50. A frustrum shaped funnel 52 with curved walls is formed in the middle portion of the interior frame 45 and begins at a lower central aperture 53 located in the top wall of the receiving slot 51 above the central portion of the central elongated slot 50 and ends in a top structure at the base of the top portion of the interior frame 45 below the fan 44. In this embodiment the top structure is a rib and spoke structure to provide multiple apertures into the fan. In other embodiments the top structure could be an open structure forming one large aperture below the fan.

The particulate air sampler 40 and removable low profile air testing cassette 60 are designed to form an air flow path 55 through the particulate air sampler 40 driven by operation of the fan 44 by the onboard computing apparatus 20. When the fan 44 is in operation, air is drawn in through air inlet 41 and directed down 55a between the channels in the vertical fins 46 and drawn into the edge slit 48 and along 55b the channel 49 where it is directed 55c and concentrated through the central elongated slit 50 towards the particulate capture material 63 on the support surface 62 which acts to capture mold spores and other particulate matter in the air. In one embodiment the particulate capture material 61 is a transparent or translucent gel material but may be other suitable materials such as sticky paper. In one embodiment the support surface is a microscope slide. After being directed towards particulate capture material 63, the air flows around 55d the edges of the support surface 62 and through 55e the lower central aperture 52 and the funnel 52 directs the air 55f towards the top structure where it is drawn 55f through the fan 44 and exits 55h the particulate air sampler 40 through the air outlet 43 which is formed as a grid of channels through the top wall of the housing 42. To create an airtight flow through the particulate air sampler 40 a first O-ring 57 is located in a circumferential recess in the outer wall of housing 42 to form an upper seal between the housing 42 and the interior frame 45 above the vertical fins 46 and a second O-ring 58 is located in a circumferential recess in the outer wall of the base 47 to form a lower seal between the housing 42 and the base 47 below the edge slit 48.

The particulate air sampler 40 is configured to sit in the rear tray portion 13 of the re-useable sampler docking station 10 of the housing. FIG. 8 is front view of the re-useable sampler docking station supporting the particulate air sampler 40 with the cover 30 removed. When placed in the rear tray a connector is connected to the fan power and speed sensor port 25 in the rear of the front portion 12 of the re-useable sampler docking station 10 to supply power to, and control operation of the fan 44.

The air sampling apparatus 1 is configured to allow periodic or on demand collection of air samples on the which particulate matter is captured by the particulate capture material 63 of the removable low profile air testing cassette 60. After some period of use the removable low profile air testing cassette 60 can be removed from the air sampling apparatus 1 and sent away to a laboratory for analysis to detect the presence of mold spores or other particulate matter of interest (biological particles, inert particles, fibers, etc.).

In the normal resting (or dormant) state, the particulate air sampler 40 is covered by air sampler cover 30 in a rest position to substantially prevent air flow through the particulate air sampler 40. When it is desired to obtain a mold sample, the cover 30 is moved into a sampling position to expose at least a portion of the air inlet 41 and air outlet 43 of the particulate air sampler 40 to allow air flow through the particulate air sampler 40. The fan is then switched on, and after a sampling period, the fan is switched off and the cover moved back to the rest position. This may be a manual operation in which an operator manually moves the cover between the rest and sampling locations and turns the fan on and off using the user interface buttons 22. In some embodiments the sampling is a computer-controlled operation, in which the computing apparatus 20 turns on the cover actuator 14 to drive (move) the cover 30 from the resting location to the sampling location to expose the air inlet 41 and air outlet 43 of the particulate air sampler 40. The computer apparatus 20 then switches on the fan 44 (via port 25) for the respective sampling period, after which the fan is stopped, and the computer then controls operation of the cover actuator to drive the cover 30 back to the sampling location. FIG. 9 shows a front view of the particulate air sampler 40 sitting on the tray with the cover moved into the sampling position by an actuator 14, which in this embodiment is a solenoid-controlled post. The computer drives the post from a retracted position to an extended position (and back again). In this embodiment the post rests on the base of a side wall of the cover 30 and a hinge 33 is provided in the rear base of the air sampler cover 30 with a substantially horizontal axis aligned along the rear edge of the tray 18. When the post moves into the extended position, the cover 30 then pivots (rotates) about hinge 33. In this embodiment a single post is used, but it will be understood that multiple posts could be used, for example on under each side wall.

Air sampling (e.g. movement of the cover and operation of the fan) may be performed according to a schedule stored in the memory of the computing apparatus 20. The schedule may store one or more start times and an associated stop time or sampling duration, along with any specific details such as fan speed, and the recurrence (hourly, daily, specific days, weekly, etc.). The sampling schedule may be set (and changed) using the user interface buttons 21 and external display 21, or it may be set using a remote-control application executing on a remote computing apparatus, which communicates schedule to the computing apparatus 20 over a wireless connection. Mold sampling may also be performed on demand using the user interface buttons 21 or using a remote-control application executing on a remote computing apparatus. A default schedule may be stored in the memory, along with one or more schedule templates which a user can select or modify, or the user may program their own custom schedule. For example, a person undergoing chemotherapy may select or program a schedule that performs frequent sampling, such as every hour, and replace the removable low profile air testing cassette 60 daily. In contrast an asthmatic may perform sampling daily, and only replace the removable low profile air testing cassette 60 weekly or monthly.

The sampling duration may be selected based on factors such as the sampling frequency (e.g. how often samples are collected), the speed of the fan, estimated or measured air flow rate, battery capacity, etc.). In some embodiments the sampling duration is a relatively short duration such as tens of seconds, e.g., 25, 30, 40, 50, 60, 90 seconds, or multiple minutes e.g., 1, 2, 3, 4, 5. The same sampling duration may be used for each sample, or the duration may be varied from sample to sample. The sampling duration may be logged by the computing apparatus 20 along with the number of samples taken with the current air testing cassette 60. The computing apparatus 20 may be configured to generate an alert when a threshold amount of use has occurred based on the logged data. This may based on a time based threshold, some as total minutes of use e.g., number of samples multiplied by the fixed duration, or simply a count of the total duration since last change. In other embodiments an alert may be generated based on the number of days since it was last changed, for example a monthly reminder may be issued to change the air testing cassette 60. The user can also choose to remove the air testing cassette 60 at any time and send it away for testing. In some embodiments a sensor may detect the removal or insertion of an air testing cassette 60. In other embodiments the user may use the user interface buttons 22 to log the change (e.g., the memory stores the change).

The removable air testing cassette 60 is configured to horizontally (y) inserted and removed from the particulate air sampler 40, and is designed with a low vertical profile, that is a small height 66 (z dimension). In some embodiments the support surface 62 is a microscope slide and the frame 61 has sufficient vertical thickness (vertical z extent) to support the microscope and is configured to provide a small vertical (z) stand-off clearance on the underside of the support surface on which the particulate capture material 63 is located. This assists in preventing accidental contamination if the removable air testing cassette 60 is placed on a surface such as benchtop after removal from the particulate air sampler 40. In this example a shelf may be formed in the interior perimeter of the frame 61 which acts to both support the support surface 62 and to provide the vertical stand off clearance. Using a low profile (small z dimension) has the advantage that removed cassette 60 can be sent off to a testing laboratory in a low profile container such as envelope. A cap or cover may be provided for the air testing cassette 60 to protect the particulate capture material 63 prior to, insertion of the air testing cassette 60 into the air sampling apparatus 1, and/or to protect the particulate capture material 63 during mailing back to the testing laboratory. The cap or cover could be configured to store and protect multiple air testing cassette 60 (for example with multiple bays).

FIG. 10A is perspective view of the low profile air testing cassette 60 in an envelope 70 for shipping to a testing laboratory and FIG. 10B is side view of the low profile air testing cassette 60 in an envelope 70 according to an embodiment. In some embodiments the height (z dimension) is less than 6 mm or 5 mm so as to fit inside an overnight letter and suitable for mailing in a standard mailbox. In some embodiments the low profile air testing cassette 60 has dimensions of 30 mm×25 mm (and a height of less than 6 mm) to allow multiple cassettes to fit inside a single standard business envelope. For example, in the US the maximum thickness of a letter is 6.35 mm (¼″) and in Australia the maximum thickness is 5 mm. The horizontal length (y) and width (x) dimensions are selected to match the dimensions of the particular air sampler 40. In some embodiments the particulate air sampler 40 uses a DC fan 40 with (x,y,z) dimensions of 40 mm×40 mm×10 mm, and thus the horizontal length (y) and width (x) dimensions are selected to be slightly less than this size, such as 38 mm×38 mm. The dimensions are also small enough to allow it to fit inside a standard envelope. For example, the standard business size letter in the US is the #10 letter with dimensions of 241 mm×105 mm (9.5″×4/125″) and accommodates folded US letter size paper (8.5″×11″). Another standard letter size is DL with dimensions of 110 mm×220 mm suitable for mailing folded A4 paper. The UPS define a maximum envelope size for mailing a letter in the US as 292 mm×156 mm (11.5″×6.25″) and a thickness of no more than 6.4 mm (¼″). Envelopes larger than this size are considered parcels and charged at higher shipping rates. In Australia the maximum envelope size for mailing is 240 mm×130 mm and a thickness of no more than 5 mm. Thus, selecting a horizontal length (y) and width (x) dimensions to be less than 40 mm×40 mm, and a thickness of less than 5 mm, allows multiple air testing cassette 60 to be mailed in the same envelope 70 for laboratory testing. In Australia, large letters are allowed to have a thickness of up to 20 mm, whilst the US allows large letters to have a maximum thickness of 19 mm (0.75″). Thus, in some embodiments the height (z dimension) is selected to be less than 19 or 20 mm. However larger heights could be used if sent in a parcel.

The envelope can be an express overnight letter allowing fast return to the testing laboratory where the air testing cassette 60 can be checked for the presence of mold spores, or other undesirable particulate matter, and the user alerted if mold or other undesirable particulate matter is found. An alert signal can be sent to the air sampling apparatus 1, and the computer apparatus 20 may generate an alert to the user, for example a visual alert on the display 21 and/or an audio alert. The alert signal or electronic report can also be sent to an electronic address, such as the user's email address or to a monitoring app registered to the use, for example that executes on a remote user computer operated by the user and used to control the air sampling apparatus.

In some embodiments the particulate air sampler 40 is a semi-consumable particulate air sampler that can be periodically replaced. For example, during use, air is drawn through particulate air sampler, and it possible that over time, mold, dust and other particles may build up along the air flow path of the particulate air sampler 40, for example channels 49 or on funnel 52, or on other internal surfaces of the air sampler. Thus, it may be desirable to replace the particulate air sampler to ensure accurate readings, or to prevent a new colonization from any spores located on the device. For example, if mold spores are detected, the sampling site may be treated to kill such spores. To prevent recolonization or regrowth, the particulate air sampler 40 may be replaced at the same time of treatment. This may be a low-cost part compared to the docking station which includes sensors and electronic equipment. In some embodiments the computing system may issue a reminder to replace the particulate air sampler 40 after a fixed time period, such as 6, 12, 18 or 24 months. Replacement of the particulate air sampler 40 may be performed by first removing the cover 30. FIG. 8 shows a front view of the particulate air sampler 40 sitting on the tray with the cover fully removed 30 to allow replacement of the particulate air sampler 40. With the cover removed, the connection to the fan power and speed sensor port 25 is disconnected, and the particulate air sampler 40 removed from the rear tray 13 and replaced with a new particulate air sampler 40. The connector can then be reconnected to fan power and speed sensor port 25 and the cover put back on.

FIG. 11 is a flow chart 100 of an operational cycle of the air sampling apparatus according to an embodiment. The operational cycle of the air sampling apparatus 1 comprises collecting multiple air samples. Each collection comprises moving the cover from the resting location to the sampling location 102. The fan is switched on for a sampling duration (time period) 104 to draw air through the air sampling arrival and is then switched off. The cover is then moved from the sampling location to the resting location 105. After multiple air sampling cycles 108, the air-testing cassette is removed and mailed to a testing laboratory 110. An alert signal may be transmitted to the air sampling apparatus and/or test results may be electronically transmitted to the user 112, for example as an electronic report to an email address or to the user's monitoring app.

Airborne particles in the air drawn through the particulate air sampler may be captured using inertial impaction. The fan is used to create an air flow through the device and the slit 50 is used to accelerate the air and direct it at the particulate capture material on the support surface so that the air velocity forces the particles to impact into particulate capture material where they become captured. The particulate capture material may be a sticky and optically clear (transparent or translucent) material such as gel which can collect and hold particles at least until the air-testing cassette is analyzed. As the particles pass through the slit 50 the air velocity forces the particles to impact into the particulate capture material, while the support surface 62 forces the air stream to make a sharp 90° turn around the slide and then out through the funnel 52.

In the above embodiments, an axial fan is used to drive air flow through the air sampling apparatus 1. However, it is to be understood that any fan or pump arrangement may be used to create the desired air flow through the air sampling apparatus 1, and in particular through the particulate air sampler and over the air-testing cassette. In other embodiments the fan may be centrifugal fan, or a bladeless fan using the Coanda effect, or a pump including piston pumps, diaphragm pumps, peristaltic pumps, and piezoelectric pumps. Piston and diaphragm pumps mechanically displace the fluid to create flow typically using a reciprocating piston or diaphragm and thus avoid the use of rotating fan or propeller. Peristaltic pumps work by compressing and releasing a flexible hose or tube, to push the liquid through the tube, and avoid the fluid coming into contact with moving parts such as fan blades (on which spore particles could lodge). Piezoelectric pumps use piezoelectric materials to create a flow by changing shape when an electric field is applied. In other embodiments, the air flow may be created by a pumping apparatus that creates a pressure differential to cause the air to move from a region of high pressure to a region of low pressure. The choice of which fan or pump may be based on cost and size and the desired flow rate. For example, axial fans can be obtained in a range of sizes at low cost. The air flow path through the particulate air sampler 40 may be configured based on the type of fan or pump used, which may influence where the fan or pump is mounted, and this may then affect the overall shape of the air sampling apparatus 1. Thus, the embodiment shown in FIGS. 1-10 represents one shape, and other shapes may be used.

The fan or pump may be configured to operate at a flow rate of between a predefined range such as 3-20 Liters per minute, or may be set to a target value such as 10 liters per minute or a range around a target value such as 8-13 L per minute. The flow rate can be determined based on a calibration process in which the flow rate at different power levels is measured, or it may be estimated using known information such as the fan speed and fan dimensions. The flow rate may be adjusted based on atmospheric data such as temperature, humidity and/or atmospheric pressure, with different speeds selected for different atmospheric conditions.

The testing laboratory may use microscopy techniques including automated analysis techniques to analyze the air-testing cassette (and in particular the particulate capture material). This may include the of phase contrast microscopy and include the use of manual and automated detection and counting. Automated detection and counting may be performed using Machine Learning or AI software trained to recognize the type of particulate matter, and count each type. The particulate material may include organic and inorganic particulates including mold spores, pollen, dust, insect parts, skin cell fragments, ash, oil droplets, paint, microorganisms, etc., as well as fibers including asbestos, fiberglass, cellulose, clothing fibers. In some embodiments the testing laboratory may use genomic based analysis technologies to analyze the particulate capture material in the air-testing cassette. This may include the use of sequencing (RNA, DNA, and protein), PCR, microarray, mass spectrometry, antibody-antigen assays, and other immunoassay technologies. These may be used to detect one or more specific microorganisms (mold spores, bacteria, viruses, etc) by detecting specific sequences or proteins, including detection of specific sets of microorganisms (e.g., panel type approaches). Detection may include presence/absence detection as well as quantification. Genomic testing may also include metagenomic and meta transcriptomic based analysis technologies for characterizing the range of microorganisms captured in the particulate capture material. An electronic report may be generated from the results of the testing and provided to the user (e.g. via email, computational portal or app).

Other variations are possible. In some embodiments a barcode reader is mounted in the interior frame 45 to read a barcode on the removable low profile air testing cassette 60. The barcode can be provided to the computer apparatus and stored by the memory. The air quality sensors 23 may be switched on, or samples collected according to the same sampling schedule as the air sampling, or adjacent in time, for example just before or after an air sample is taken, or according to a different schedule. The computing apparatus may also include additional sensors, such as location-based sensors including global navigation system receiver, or an IMU to detect movement.

The computing apparatus may include a scheduler to control timing of sampling, and overall operation of the air sampling apparatus to reduce power consumption. The air sampling apparatus may be configured to operate for months between battery replacement or recharging, by entering a low power sleep mode.

The particulate air sampler and removable air-testing cassette may be 3D printed or injection molded from plastics to provide low-cost parts. In some embodiments the plastics are non-static plastics. In some embodiments the parts may be made of metals or other materials. The fan may be commercial fan such as 40×40×10 mm fan with a three wire connector. In some embodiments the air sampling apparatus may be plugged into a permanent power source (e.g. wall plug etc.) and may omit a battery. In some embodiments the cassette has a unique identifier such as a barcode or serial code, to provide for chain-of-custody tracking, and for billing analysis services. In some embodiments a cover actuator may be omitted and the air from fan is used to push the cover upwards, for example by providing a channel to the base of the cover. In some embodiments the air sampler cover may be omitted, and the air inlets and air outlets may be permanently exposed. In some embodiments actuatable internal covers may be located within the air flow channel of the particulate air sampler to seal off the cassette from the rest of the air flow channel to prevent contamination of the particulate capture material. Other variations are possible.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, middleware, platforms, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two, including cloud-based systems. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein, or a combination thereof. Various middleware and computing platforms may be used.

In some embodiments the processor module comprises one or more Central Processing Units (CPUs) or Graphical processing units (GPU) configured to perform some of the steps of the methods. Similarly, a computing apparatus may comprise one or more CPUs and/or GPUs. A CPU may comprise an Input/Output Interface, an Arithmetic and Logic Unit (ALU) and a Control Unit and Program Counter element which is in communication with input and output devices through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc.). The computing apparatus may comprise a single CPU (core) or multiple CPU's (multiple core), or multiple processors. The computing apparatus may be a cloud-based computing apparatus using GPU clusters, a parallel processor, a vector processor, or be a distributed computing device. Memory is operatively coupled to the processor(s) and may comprise RAM and ROM components and may be provided within or external to the device or processor module. The memory may be used to store an operating system and additional software modules or instructions. The processor(s) may be configured to load and executed the software modules or instructions stored in the memory.

Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The system may be a computer implemented system configured to perform any one of the computers implemented methods described herein. The computing system may comprise one or more processors including multi-core CPUs and Graphical Processing Units (GPUs) operatively connected to one or more memories which store instructions to configure the processor to perform embodiments of the method. In this context, the computing system may include, for example, one or more processors (CPUs, GPUs), memories, storage, and input/output devices (e.g., monitor, keyboard, disk drive, network interface, Internet connection, etc.). However, the computing system may include circuitry or other specialized hardware for carrying out some or all aspects of the processes. The computing system may be a computing apparatus such as an all-in-one computer, desktop computer, laptop, tablet or mobile computing apparatus, server, and any associated peripheral devices. The computer system may be a distributed system including server-based systems and cloud-based computing systems. The computing system may be a unitary computing or programmable device, or a distributed system or device comprising several components operatively (or functionally) connected via wired or wireless connections. In some operational settings, the computing system may be configured as a system that includes one or more devices, each of which is configured to carry out some aspects of the processes either in software, hardware, or some combination thereof. For example, a user interface may be provided on a desktop computer or tablet computer, whilst data processing may be performed remotely on a server-based system including cloud-based server systems, and the user interface is configured to communicate with such servers to exchange data and results. The user interface may be provided as a web portal, allowing a user on one computer to upload data which may be processed on a remote computing apparatus or system (e.g., server or cloud system) and which provides the results (i.e., the report) back to the user, or to other users on other computing apparatus.

The computing apparatus may comprise one or more processors including a central processing unit (CPU), one or more memories, and may include an input/output interface which may include a display apparatus, and/or an input device such as buttons, a keyboard, a mouse, etc. The display apparatus may be a touch screen which also acts as an input device. The CPU comprises an Input/Output Interface, an Arithmetic and Logic Unit (ALU) and a Control Unit and Program Counter element which is in communication with input and output devices (e.g. input device and display apparatus) through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc). A graphical processing unit (GPU) may also be included. The display apparatus may comprise a flat screen display (e.g. LCD, LED, plasma, touch screen, etc), a projector, CRT, etc. The computing device may comprise a single CPU (core) or multiple CPU's (multiple core), or multiple processors. The computing device may use a parallel processor, a vector processor, or be a distributed computing device. The memory is operatively coupled to the processor(s) and may comprise RAM and ROM components, and may be provided within or external to the device. The memory may be used to store the operating system and additional software modules or instructions. The processor(s) may be configured to load and executed the software modules or instructions stored in the memory. A computer program may be written, for example, in a general-purpose programming language (e.g., Pascal, C, C++, Java, Python, JSON, etc.) or some specialized application-specific language, and may utilise or call software libraries or packages.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

Please note that the following claims are not intended to limit the scope of what may be claimed in any future patent applications based on the present application. Integers may be added to or omitted from the claims at a later date so as to further define or re-define the scope.

1. An air sampling apparatus comprising:
a removable air-testing cassette comprising a frame, a support surface, and a particulate capture material, wherein the frame supports the support surface, and the particulate capture material is located on at least one side of the support surface, wherein a thickness of the removable air-testing cassette is less than 20 mm; and
a docking station comprising:
an electronically controllable air flow apparatus;
a particulate air sampler located within the docking station comprising a housing and an interior frame, wherein the housing comprises one or more air inlets, one or more air outlets, and a receiving aperture configured to receive and support the removable air-testing cassette, wherein the interior frame comprises a slit located below the particulate capture material and the particulate air sampler is configured with an air flow path such that when the electronically controllable air flow apparatus is switched on, air is drawn into the particulate air sampler by the one or more air inlets and is directed through the slit to the particulate capture material on the support surface, and then out through the one or more air outlets; and
a control circuit configured to receive at least a start input from a user input actuator to trigger a sampling cycle by switching on the electronically controllable air flow apparatus on for a predefined sampling interval.

2. The air sampling apparatus as claimed in claim 1, wherein the removable air-testing cassette has a thickness of less than 6.5 mm.

3. The air sampling apparatus as claimed in claim 1, further comprising an air sampler cover configured to be moved between a resting location in which the particulate air sampler apparatus and the one or more air inlets and one or more air outlets are covered, and a sampling location in which the cover is moved to a location to expose at least a portion of the one or more air inlets and one or more air outlets are uncovered, and comprising a rear access opening to allow insertion and removal of the removeable air testing cassette into the receiving aperture in the particulate air sampler, wherein the control circuit is further configured to actuate movement of the air sampler cover to the sampling location prior at the start of a sampling cycle, and to return the cover back to the resting position at the end of the sampling cycle.

4. The air sampling apparatus as claimed in claim 1, wherein the electronically controllable air flow apparatus is a fan, and is located within the particulate air sampler.

5. The air sampling apparatus as claimed in claim 1, wherein the control circuit is a computing apparatus comprising one or more processors, one or more memories, and an input/output interface wherein the one or more processors are configured to switch the electronically controllable air flow apparatus on and off, according to a sampling schedule stored in the memory, or on receipt of a sampling signal received from the input/output interface.

6. The air sampling apparatus as claimed in claim 4, wherein the docking station further comprises a cover actuator, and the memory further comprises instructions to actuate the cover actuator to move the air sampling cover from the resting location to the sampling location prior to switching the fan on, and after switching the fan off the cover actuator is actuated to allow the air sampling cover to move back to the resting location.

7. The air sampling apparatus as claimed in claim 1, wherein the particulate air sampler and cover are removable from the docking station.

8. The air sampling apparatus as claimed in claim 1, wherein the electronically controllable air flow apparatus is configured to generate a flow rate of between 3 and 20 Liters per minute.
